(19) United States
(12) Patent Application Publication
(10) Pub. No.: US 2014/0260868 A1
(43) Pub. Date: Sep. 18, 2014

(54) Slitting Machine

(71) Applicant: DIENES CORPORATION USA, Spencer, MA (US)

(72) Inventor: Charlie Comeau, Brimfield, MA (US)

(73) Assignee: Dienes Corporation USA, Spencer, MA (US)

(21) Appl. No.: 13/843,999

(22) Filed: Mar. 15, 2013

(51) Int. Cl. B26D 7/26

(52) U.S. Cl. CPC B26D 7/2635
USPC 83/469

(57) ABSTRACT

A slitting machine having at least two knife holders, with a respective knife rotatably mounted on each knife holder. Individually activatable electromagnetic sensors are disposed on the knife holders, and a single magnetostrictive rod extends through a portion of all of the electromagnetic sensors. A unit processes interrogations by the rod of activated ones of the electromagnetic sensors for indicating the position of at least one of the knife holders relative to the rod.

### BACKGROUND OF THE INVENTION

The present invention relates to a slitting machine, in particular a slitting machine that is capable of indicating the position of at least one of its knife holders.

With heretofore known slitting machines of this type, position sensing of knives along a magnetostrictive rod has been limited by two factors, namely the minimum distance apart that the sensors can be placed on the rod due to their magnetic properties, and the total number of sensors allowed by the rod. Thus, the known slitting machines cannot provide the desired accuracy with respect to determining the position of knife holders, and hence of their knives, relative to the rod.

It is therefore an object of the present application to overcome the drawbacks of the prior art and to thereby provide far greater accuracy with regard to the ability to indicate the position of the knife holders relative to the magnetostrictive rod.

### BRIEF DESCRIPTION OF THE DRAWINGS

This object, and other objects and advantages of the present invention, will appear more clearly from the following specification in conjunction with the accompanying schematic drawings, in which:

FIG. 1 is a side view of one exemplary embodiment of a slitting machine of the present application, showing a representative knife holder and electromagnetic sensor along with an associated magnetostrictive rod;

FIG. 2 shows a side view and front view of one exemplary embodiment of an electromagnetic sensor for the slitting machine of FIG. 1; and

FIG. 3: shows a comparison between the limited number of knives/sensors possible with prior art devices and the essentially unlimited number of knives and their electromagnetic sensors that are possible with the slitting machine of the present application.

### SUMMARY OF THE INVENTION

The slitting machine of the present application comprises at least two knife holders, each of which has a respective knife rotatably mounted thereon; individually activatable electromagnetic sensors disposed on the knife holders; a single magnetostrictive rod, wherein the electromagnetic sensors are also disposed along a length of the rod; and means for processing an interrogation by the rod of activated ones of the electromagnetic sensors, and for indicating the position of at least one of the knife holders relative to the rod.

Pursuant to one presently preferred embodiment, the electromagnetic sensors are each a two-wire device that takes an electrical current and passes it though mag wire wrapped over an alloy core that is specifically shaped to produce a south pole field in the C or U shaped head of the electromagnetic sensor. This field is controlled by the input voltage to the electromagnetic sensor, which produces the required Gauss strength to be read by the magnetostrictive rod, which in turn provides feedback for indicating the exact position of the designated knife. The magnetostrictive rod, which is stationarily supported at opposite ends via brackets, extends through the C or U shaped portions of all of the electromagnetic sensors.

The electromagnetic sensors can be turned on and off as needed to capture the positions of various ones of the knife holders, and hence the knives thereof. Thus, the electromagnetic sensors can be arranged adjacent to one another as close as is allowed by the thickness or width of the knife holders on which they are mounted.

Again, since the electromagnetic sensors can be turned on in groups, the physical number of electromagnetic sensors that can be disposed on a single magnetostrictive rod is now virtually limitless.

Further specific features of the present invention will be described in detail subsequently.

### DESCRIPTION OF SPECIFIC EMBODIMENTS

Referring now to the drawings in detail, the slitting machine of the present application is designated generally by the reference numeral 20 in FIG. 1, and includes a plurality of knife or blade holders 22, only one of which is visible in FIG. 1, the angle of viewing of which is parallel to the direction of displacement of the knife holders 22. Associated with each knife holder 22 is a blade or knife 23 that is rotatably mounted on the knife holder, an electromagnetic sensor 24 that is fixedly mounted on the knife holder, a single magnetostrictive rod 25, and means 27, such as a computer, for processing an interrogation by the magnetostrictive rod 25 of the electromagnetic sensor 24.

The electromagnetic sensors 24 have a C or U shaped portion (see FIG. 2) through which the single magnetostrictive rod 25 extends. The rod 25 is stationarily mounted, so that as the knife holders 22 are displaced, the electromagnetic sensors 24, which due to their fixed mounting on the knife holders 22 travel along with it, are correspondingly displaced along the length of the magnetorestrictive rod 25, which extends in a direction parallel to the direction of displacement of the knife holders 22. When one of the electromagnetic sensors 24 is activated, in other words when power is supplied to it, the electromagnetic sensor creates a magnetic field. This magnetic field can be sensed by the magnetostrictive rod 25, and the signal generated is conveyed from the magnetostrictive rod 25 to the computer or other means 27 for processing such an interrogation of the activated electromagnetic sensor 24. The means 27 can then provide feedback regarding, i.e. can indicate, the position of the electromagnetic sensor 24, and hence of the blade holder 22, relative to the magnetostrictive rod 25. In one exemplary embodiment, the sensor 24, made from a cold rolled steel blank, is wound with 28 ga mag wire (six passes). The blank has a thickness of, for example, 0.08 inches.

Thus, as the knife holders 22, along with their knives 23, are appropriately positioned for slitting by being displaced on a rail or cross beam, the electromagnetic sensors 24 are moved along with the knife holders 22 on which they are fixedly mounted. By activating a number of electromagnetic sensors 24 in a staggered manner, not only can the position of the knife holders 22 relative to the magnetostrictive rod 25 be detected and indicated, but also the position of the knife holders 22 relative to one another can be indicated.

FIG. 3 schematically indicates how pursuant to the slitting machine of the present invention, the number of knife holders 22, and hence the number of associated electromagnetic sensors 24, that can be provided using only a single magnorestrictive rod 25 for the electromagnetic sensors, is limited only by the relatively narrow thickness or width of the knife holders 22, and of course the length of the rod 25. This for the first time possible, immediately adjacent to one another arrangement of the knife holders 22 is due to the fact that with the slitting machine of the present application, the electromagnetic sensors 24 can be turned on and off in a staggered manner. The minimal spacing between adjacent knife holders 22 that can be achieved with the present invention provides for a far greater accuracy in determining the exact position of a given knife 23. For example, whereas with heretofore known devices, the permanent magnets provided on a single magnetostrictive rod had to be spaced at least two to two and a half inches apart, with the slitting machine of the present application the electromagnetic sensors 24 can be spaced one half inch or even less apart on a single magnetostrictive rod 25.

The present invention is, of course, in no way restricted to the specific disclosure of the specification and drawings, but also encompasses any modifications within the scope of the appended claims.

What we claim is:

1. A slitting machine, comprising:
at least two knife holders (22), each of which has a respective knife (23) rotatably mounted thereon;
individually activatable electromagnetic sensors (24) disposed on said knife holders (22);
a single magnetostrictive rod (25), wherein said electromagnetic sensors (24) are also disposed along a length of said rod; and
means for processing an interrogation by said magnetostrictive rod (25) of activated ones of said electromagnetic sensors (24), and for indicating the position of at least one of said knife holders (22) relative to said rod (25).

2. A slitting machine according to claim 1, wherein each of said electromagnetic sensors (24) has a C or U shaped portion that extends about said magnetostrictive rod (25).

3. A slitting machine according to claim 1, wherein said electromagnetic sensors (24) are activatable in groups.
